(19) United States
(12) Patent Application Publication
(10) Pub. No.: US 2025/0264490 A1
(43) Pub. Date: Aug. 21, 2025

(54) AUTOMATED FILTRATION SYSTEM WITH AUTOMATED ROTARY VIAL UNCAPPING SYSTEM AND FILTER REMOVAL

(71) Applicant: Elemental Scientific, Inc., Omaha, NE (US)

(72) Inventors: Tyler Herek, Omaha, NE (US); Daniel R. Wiederin, Omaha, NE (US); Matthew Anderson, Omaha, NE (US); Andrew Micek, Omaha, NE (US); Caleb Gilmore, Omaha, NE (US)

(21) Appl. No.: 19/051,925

(22) Filed: Feb. 12, 2025

Related U.S. Application Data
(60) Provisional application No. 63/554,345, filed on Feb. 16, 2024.
(60) Provisional application No. 63/687,547, filed on Aug. 27, 2024.
(60) Provisional application No. 63/730,782, filed on Dec. 11, 2024.

(51) Int. Cl. G01N 35/10; G01N 35/00; G01N 35/04

(52) U.S. Cl. CPC G01N 35/10; G01N 35/04; G01N 2035/00475; G01N 2035/0405; G01N 2035/1053

(57) ABSTRACT

Automated systems are described that remove a cap from a capped sample container, introduce a probe to the uncapped sample container, direct the sample through the filter to provide a filtrate, and transfer the filtrate to another uncapped sample container, a sample fluid line in fluid communication with a sample analysis system, or combinations thereof.

### CROSS-REFERENCE TO RELATED APPLICATIONS

The present application claims the benefit of 35 U.S.C. § 119(e) of U.S. Provisional Application Ser. No. 63/554,345, filed Feb. 16, 2024, and titled “AUTOMATED FILTRATION SYSTEM WITH FILTERS HAVING AN INTEGRATED PROBE,” of U.S. Provisional Application Ser. No. 63/687,547, filed Aug. 27, 2024, and titled “AUTOMATED ROTARY VIAL UNCAPPING SYSTEM,” and of U.S. Provisional Application Ser. No. 63/730,782, filed Dec. 11, 2024, and titled “AUTOMATED FILTRATION SYSTEM WITH AUTOMATED ROTARY VIAL UNCAPPING SYSTEM AND FILTER REMOVAL.” U.S. Provisional Applications Ser. Nos. 63/554,345, 63/687,547, and 63/730,782 are herein incorporated by reference in their entireties.

### BACKGROUND

In many laboratory settings, it is often necessary to analyze a large number of chemical or biochemical samples located in individual sample containers. In order to stream-line such processes, the manipulation of samples has been mechanized. Such mechanized sampling is commonly referred to as autosampling and is performed using an automated sampling device or autosampler.

### SUMMARY

Automated systems are described that remove a cap from a capped sample container, introduce a probe to the uncapped sample container, direct the sample through a filter to provide a filtrate, and transfer the filtrate to another uncapped sample container, a sample fluid line in fluid communication with a sample analysis system, or combinations thereof. In an aspect, a system embodiment includes, but is not limited to, an autosampler arm configured to couple with a sample probe having a filter coupled to the sample probe, the autosampler arm configured to position the sample probe within a first sample container holding a fluid sample for filtering and subsequent analysis; a pump/vacuum source configured to remove at least a portion of the fluid sample from the sample container and to transfer fluid sample through each of the filter and the sample probe to generate a filtrate; and a control system communicatively coupled with each of the autosampler arm and the pump/vacuum source to cause the autosampler arm to position the autosampler arm adjacent at least one of a second sample container or a sample port in fluid communication with an analysis system and to cause the pump/vacuum source to dispense the filtrate into at least one of the second sample container or the sample port.

In an aspect, a system embodiment includes, but is not limited to, an autosampler arm configured to couple with a sample probe having a filter coupled to the sample probe, the autosampler arm configured to position the sample probe within a first sample container holding a fluid sample for filtering and subsequent analysis; a rotary uncapper including a stage configured to support the first sample container and an uncapper head configured to remove a cap from the first sample container prior to introduction of the sample probe to the first sample container; a pump/vacuum source configured to remove at least a portion of the fluid sample from the sample container and to transfer fluid sample through each of the filter and the sample probe to generate a filtrate; and a control system communicatively coupled with each of the autosampler arm and the pump/vacuum source to cause the autosampler arm to position the autosampler arm adjacent at least one of a second sample container or a sample port in fluid communication with an analysis system and to cause the pump/vacuum source to dispense the filtrate into at least one of the second sample container or the sample port.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a schematic diagram of an automated filtration system in accordance with an example embodiment of the present disclosure.

FIG. 2 is an isometric view of an automated filtration system, such as an embodiment of the automated filtration system of FIG. 1, shown with sample containers held in sample racks and filters having integrated sample probes in accordance with an example embodiment of the present disclosure.

FIG. 3A is a side view of an autosampler arm of the automated filtration system of FIG. 2 shown with an attached filter with integrated sample probe in accordance with an example embodiment of the present disclosure.

FIG. 3B is a side view of the autosampler arm of FIG. 3A shown with a sample fluid line coupled with the autosampler arm and fluidically coupled with the filter with integrated sample probe in accordance with an example embodiment of the present disclosure.

FIG. 4 is an isometric view of a filter probe storage, such as an embodiment of the filter probe storage of the automated filtration system of FIG. 1, shown with a plurality of filters having integrated sample probes supported by a rack in accordance with an example embodiment of the present disclosure.

FIG. 5 is an isometric view of a filter retainer, such as an embodiment of the filter retainer of the automated filtration system of FIG. 1, shown in accordance with an example embodiment of the present disclosure.

FIG. 6 is a schematic diagram of a control system for the automated filtration system of FIG. 1, shown in accordance with an example embodiment of the present disclosure.

FIG. 7 is a schematic diagram of an automated filtration system in accordance with an example embodiment of the present disclosure.

FIG. 8A is a side view of a sample probe of the automated filtration system of FIG. 7, in accordance with an example embodiment of the present disclosure.

FIG. 8B is a partial cross-sectional isometric view of the sample probe of FIG. 8A shown with a particulate filter into which an end of the sample probe fits, in accordance with an example embodiment of the present disclosure.

FIG. 8C is a partial side view of the sample probe of FIG. 8A shown drawing sample fluid from a sample container in accordance with an example embodiment of the present disclosure.

FIG. 8D is a partial side view of the sample probe of FIG. 8C shown with a filter affixed to an end of the sample probe and dispensing filtrate into a different sample container in accordance with an example embodiment of the present disclosure.

FIG. 8E is a partial side view of the sample probe of FIG. 8D shown with the filter removed and dispensing another fluid to mix with the filtrate in the different sample container in accordance with an example embodiment of the present disclosure.

FIG. 9 is a schematic diagram of an automated cap removal system for making a sample container available to a sample probe of an autosampler in accordance with an example embodiment of the present disclosure.

FIG. 10 is an isometric view of an automated cap removal system of having an open sample container supported by a rotary stage with a sample probe inserted therein in accordance with an example embodiment of the present disclosure.

FIG. 11A is an isometric view of an automated cap removal system including a rotary stage configured to hold and rotate about at least two axes a fluid container having a removable cap in accordance with an example embodiment of the present disclosure.

FIG. 11B is an isometric view of the automated cap removal system of FIG. 11A, shown with the rotary stage having rotated the fluid container beneath an uncapper head in accordance with an example embodiment of the present disclosure.

FIG. 12A is a side view of the automated cap removal system of FIG. 11A, shown with an uncapper assembly configured to move the uncapper head towards the removable cap disposed on the fluid container in accordance with an example embodiment of the present disclosure.

FIG. 12B is a partial side view of the automated cap removal system of FIG. 11A, shown with the uncapper head interacting with the removable cap disposed on the fluid container in accordance with an example embodiment of the present disclosure.

FIG. 13A is a partial perspective view of the automated cap removal system of FIG. 11A, shown with a scanner interacting with a label on the fluid container in accordance with an example embodiment of the present disclosure.

FIG. 13B is a partial side view of the automated cap removal system of FIG. 13A.

FIG. 14 is a side view of a grip mechanism of the rotary stage of the automated cap removal system of FIG. 11A, shown with the grippers moveably engaging and disengaging with the fluid container in accordance with an example embodiment of the present disclosure.

FIG. 15A is a partial side view of the automated cap removal system of FIG. 11A, shown with the fluid container secured by a grip mechanism and with the uncapper head rotatably removing the cap disposed on the fluid container with an upward motion of the uncapper assembly in accordance with an example embodiment of the present disclosure.

FIG. 15B is a partial side view of the automated cap removal system of FIG. 15A, shown with the removeable cap held by the uncapper head of the uncapper assembly in accordance with an example embodiment of the present disclosure.

FIG. 16 is a partial perspective view of an underside of the uncapper head of the automated cap removal system of FIG. 11A in accordance with an example embodiment of the present disclosure.

FIG. 17 is an isometric view of the automated cap removal system of FIG. 11A, shown with the rotary stage having further rotated the position of the uncapped fluid container, such as to be accessible by a fluid probe of an autosampler, in accordance with an example embodiment of the present disclosure.

FIG. 18A is a partial side view of the automated cap removal system of FIG. 17, shown with the removeable cap held by the uncapper head of the uncapper assembly in preparation to replace the cap back onto the fluid container in accordance with an example embodiment of the present disclosure.

FIG. 18B is a partial side view of the automated cap removal system of FIG. 17, shown with the removeable cap lowered and rotated by the uncapper head of the uncapper assembly to replace the cap onto the fluid container in accordance with an example embodiment of the present disclosure.

FIG. 19A is a partial isometric view of a sample container placement system with a container gripper positioned above a sample container in accordance with an example embodiment of the present disclosure.

FIG. 19B is a partial isometric view of the sample container placement system of FIG. 19A shown with the container gripper engaging the sample container in accordance with an example embodiment of the present disclosure.

FIG. 20 is a side view of the sample container placement system of FIG. 19A shown with the container gripper engaging and lifting the sample container for transport to the automated cap removal system in accordance with an example embodiment of the present disclosure.

FIG. 21A is a partial top view of the sample container placement system of FIG. 19A shown with the container gripper engaging and positioning the sample container above the automated cap removal system in accordance with an example embodiment of the present disclosure.

FIG. 21B is a partial isometric view of the sample container placement system of FIG. 19A shown with the container gripper following placement of the sample container in the automated cap removal system in accordance with an example embodiment of the present disclosure.

FIG. 22A is a cross-sectional view of a filter disengagement system for a filter retainer, shown with the filter engaged with a sample port, in accordance with an example embodiment of the present disclosure.

FIG. 22B is a cross-sectional view of the filter disengagement system of FIG. 22A, shown decoupling the filter from the sample port via an extension configuration, in accordance with an example embodiment of the present disclosure.

FIG. 22C is a cross-sectional view of the filter disengagement system of FIG. 22A, shown in a reset configuration to facilitate removal of the filter, in accordance with an example embodiment of the present disclosure.

FIG. 23 is a cross-sectional view of the filter disengagement system of FIG. 22A, shown in a backflush and rinse configuration, in accordance with an example embodiment of the present disclosure.

FIG. 24A is a cross-sectional view of a filter disengagement system for a filter retainer, shown with the filter engaged with a sample port, in accordance with an example embodiment of the present disclosure.

FIG. 24B is a cross-sectional view of the filter disengagement system of FIG. 24A, shown decoupling the filter from the sample port via a retraction configuration, in accordance with an example embodiment of the present disclosure.

FIG. 24C is a cross-sectional view of the filter disengagement system of FIG. 24A, shown with filter removal, in accordance with an example embodiment of the present disclosure.

FIG. 25A is a cross-sectional view of the filter disengagement system of FIG. 24A, shown in a backflush and rinse configuration, in accordance with an example embodiment of the present disclosure.

FIG. 25B is an isometric view of the filter disengagement system of FIG. 24A, shown in a backflush and rinse configuration, in accordance with an example embodiment of the present disclosure.

FIG. 26 is a schematic diagram of an automated filtration system configured to direct filtrate to a sample line in fluid communication with a sample analysis system for analyte detection, in accordance with an example embodiment of the present disclosure.

### DETAILED DESCRIPTION

### Overview

Many analytical methods include a filtration step for a fluid sample prior to analyzing an analyte concentration of the sample, such as through mass spectroscopy, liquid chromatography, or other analytical techniques. The filtration step can be a manual process handled by a laboratory technician wherein the technician loads a sample from a first sample container into a syringe, attaches a filter to the syringe, and pushes the plunger on the syringe to expel sample liquid through the filter to introduce filtrate into a second sample container. The filter can be removed and disposed of after each sample filtration to prevent cross contamination between samples.

However, such manual filtering processes provide multiple health and safety concerns. For instance, many laboratories handle large numbers of sample containers, which leads to individual lab technicians repeating the same motion throughout the day. Such repeated motion can be a risk for repetitive motion injury, repetitive stress injury, and the like. These risks can increase as the force utilized by the lab technician to dispense fluid through the filter becomes larger due to small pore sizes on the associated filters, such as with micron-scale filters used in many laboratory settings. Additionally or alternatively, the risks can include risk of cross contamination or environmental exposure of sample contents if the filter is not firmly attached to or secured against the syringe during dispensing operations. For instance, if the filter is not firmly attached during a dispensing operation, the force of fluid flowing through the filter can push the filter, or a portion thereof, off the end of the syringe, which can cause sample to spray erratically from the syringe. For samples containing acids or other potentially hazardous fluids (e.g., acid-digested samples), exposure of the sample to the environment outside of the syringe or proper sample containers can injure individuals, cross contaminate other samples awaiting analysis, and so forth.

An automated sampling device, or autosampler, can automate certain sample handling procedures to save laboratory labor costs and improve reproducibility. Autosamplers can include a sample probe mounted relative to a vertically-oriented rod which moves the sample probe along or across one or more directions of movement. For instance, the sample probe can be coupled to a vertically-moveable portion of the rod by a probe support arm or other device to move the probe in a vertical direction, such as to position the probe into and out of sample container (e.g., tubes or other vessels), rinse containers, standard chemical containers, diluent containers, and the like, on a deck of the autosampler. In other situations, the rod can be rotated to facilitate movement of the probe about a horizontal plane, such as to position the probe above other sample vessels and other vessels positioned on the deck.

A probe of an autosampler can be inserted into a sample container to draw a sample through the probe and into a fluid line, however if the sample is to be filtered prior to analysis, particulates present in the sample can attach to or deposit on interior walls of the probe and/or the fluid line. Such presence of particulates can be a source of cross contamination of future samples, can lead to clogging autosampler components (e.g., requiring downtime for equipment maintenance), and the like, even if a filter is attached prior to dispensing the sample. Moreover, attempting to pass a fluid sample through a filter that has been utilized to filter particulates during a drawing procedure of the autosampler presents a risk of reintroducing the particulates back into the sample as the particulates are dislodged during the dispensing procedure. Additionally, in order to replace or change a filter, such as to avoid subsequent sample contamination, to avoid pressure buildup with the system due to filter clogging, or the like, the filter should be removed from contact with the probe. However, such a removal or replacement can require a laboratory technician to manually accommodate the process, which takes additional time and cost to facilitate, can pose additional exposure risks of the technician to particulates or latent sample in the filter, or can utilize automated processes that can jam, clog, or otherwise lead to downtime due to system failures with attempting to dislodge a filter from the probe or that loosely hold the filter onto the probe, which can result in sample flow pushing the filter off the probe during a dispensing procedure.

Further, various samples are held in capped sample vessels, such as to isolate the samples from environmental contamination or prevent evaporation or sample degradation. However, the process of uncapping and filtering a sample poses many problems with coordinating the uncapping and filtering, particularly when a new filter is utilized for each sample. Traditional vial uncapping methods are labor-intensive and prone to human error. Manual uncapping often requires repetitive motions that can lead to physical strain or injury for operators and exposes samples to potential contamination from environmental factors or human contact. In scenarios where vials contain hazardous or dangerous substances, manual handling poses a risk to the safety of users.

Accordingly, systems and methods are disclosed for automated filtering of samples using a replaceable filter configured to couple with a sample probe with subsequent removal of the filter following transfer of filtrate from the filter (e.g., into a sample container, into a sample line coupled with an analysis system, etc.). In aspects, the system utilizes a filter with an integrated probe to draw a filtered sample into a sample fluid line, remove the filter with integrated probe, and dispense filtered sample into a filtered sample container. The sample fluid line contains filtered sample, such that particulates that could otherwise attach to or deposit on interior walls of the fluid line are removed from the sample when the sample is drawn from the sample container via the integrated probe and through the filter into the sample fluid line. In aspects, the system utilizes a rigid sample probe having an end configured for insertion into a filter, where an output end of the filter can be positioned over a sample container or coupled with an input port for a sample analysis system. In an aspect, a system includes a filter retainer to permit an autosampler arm to position the filter with integrated probe into the filter retainer after a filtered sample has been drawn into the sample fluid line. The filter retainer provides a surface against which the filter with integrated probe is positioned to permit the autosampler arm to rise while the filter with integrated probe is pulled from a connector of the autosampler arm (e.g., ferrule) or while the filter is removed from the end of the sample probe.

The system can include a filter probe storage that holds a plurality of filters with integrated probes or individual filters available for the autosampler arm to attach a fresh filter prior to inserting the probe into a sample container to draw and filter a sample (e.g., for filters with integrated probes) or subsequent to drawing sample into the probe (e.g., for attaching a filter to an end of the sample probe). In an aspect, the system includes a control system to control the flow rate of sample removed from sample containers for filtration. For instance, the system can include a bubble sensor to identify whether bubbles are introduced to the sample fluid line (e.g., via high flow rate of sample through the filter), where a system controller can reduce the draw speed (e.g., through control signal(s) to a pump or vacuum source in fluid communication with the filter with integrated probe) to avoid introducing bubbles in the sample fluid line.

In aspects, the system can facilitate processing of capped sample containers with an automated cap removal system that automates the cap removal and replacement process, significantly reducing the need for manual intervention and minimizing the risk of injury associated with repetitive uncapping tasks. The automated cap removal system can facilitate movement of a sample container according to two axes of rotation, with a first axis used to rotate the sample container for cap removal and replacement via an uncapper head and a second axis used to position a rotary stage to receive the capped sample container and to make the uncapped sample container available for a sample probe to remove sample therefrom. In aspects, the automated cap removal system features an integrated barcode scanner that enhances accuracy in sample tracking and reduces human error. By automating the identification and logging of vials through barcode scanning, the automated cap removal system ensures precise tracking and data management, further improving the overall efficiency and reliability of the vial handling process. In an aspect, the automated cap removal system limits the amount of time vials are open to reduce risk of contamination and eliminates user interaction with the contents of the vials, thus protecting the user from exposure to harmful substances. In implementations, the materials used in the construction of the automated cap removal system are selected for corrosion resistance, which can ensure component longevity and reliability, even when handling vials containing corrosive substances, thereby maintaining operational efficiency and minimizing maintenance requirements.

In aspects, the filter retainer system includes a filter disengagement system to facilitate disengagement between an output end of the filter and a sample inlet port used to transfer filtrate to a sample preparation system (e.g., to introduce reagents, diluents, standard solutions, etc. to the filtrate), to a sample analysis system, or combinations thereof. The filter disengagement system can transition between differing structural configurations to remove the filter from the sample inlet port, such as to push or pull the end of the filter from the sample inlet port.

### Example Implementations

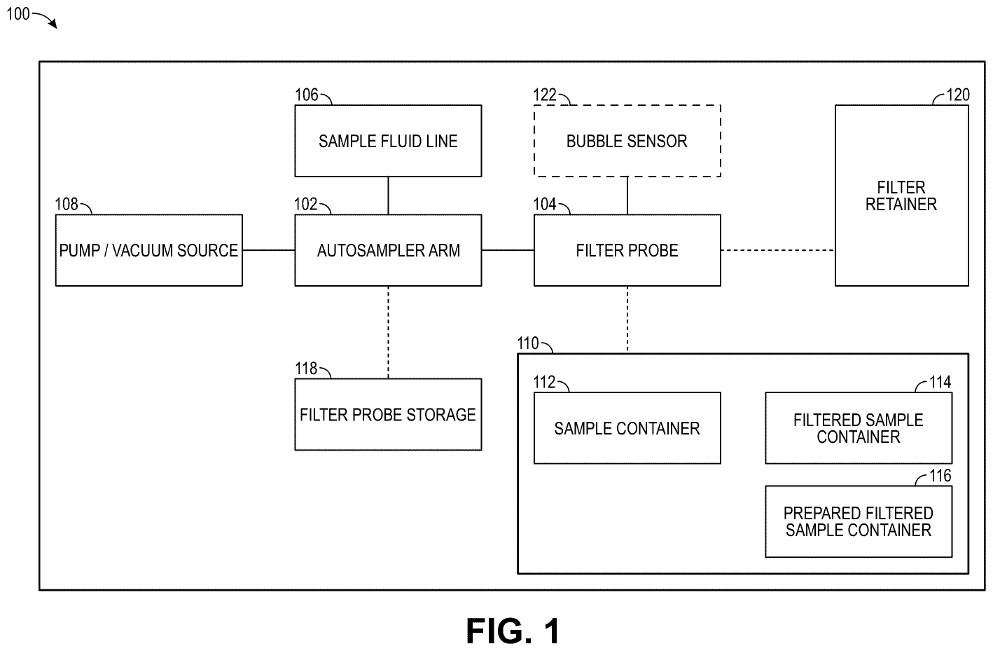

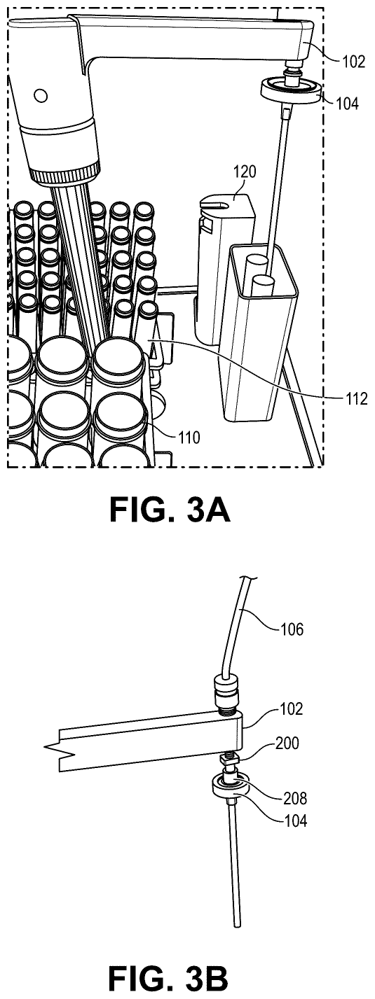

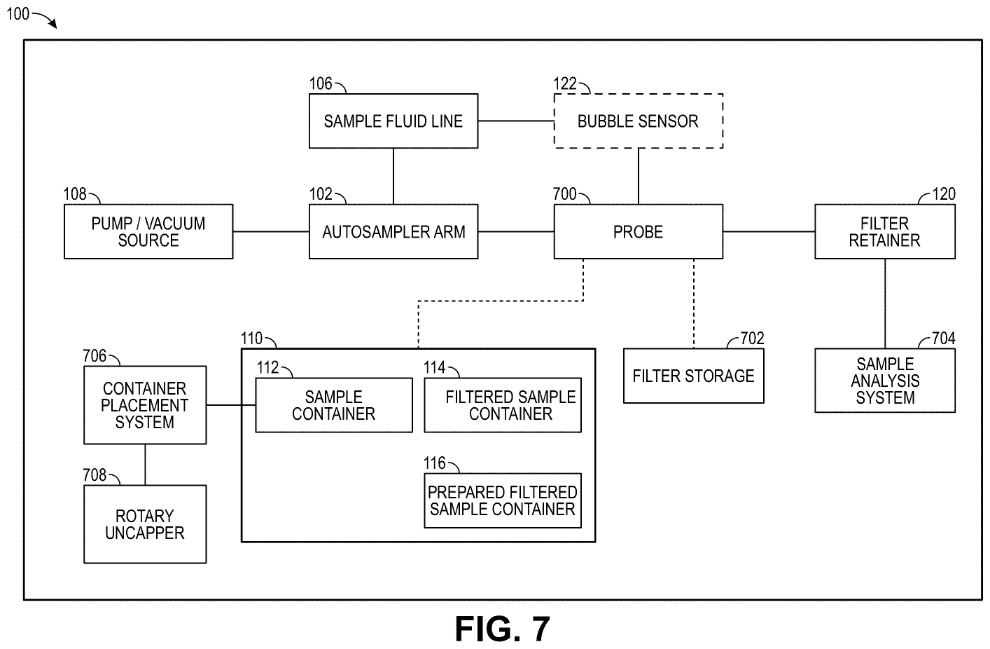

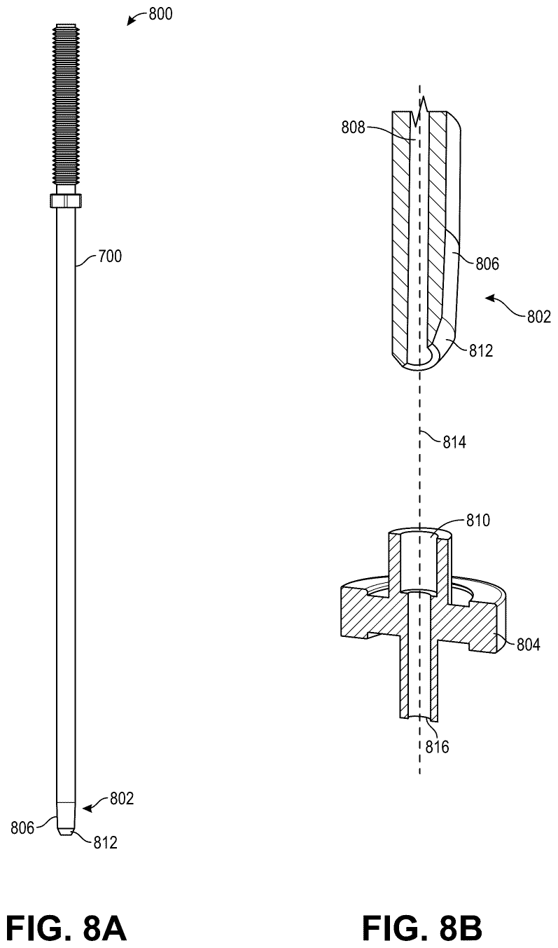

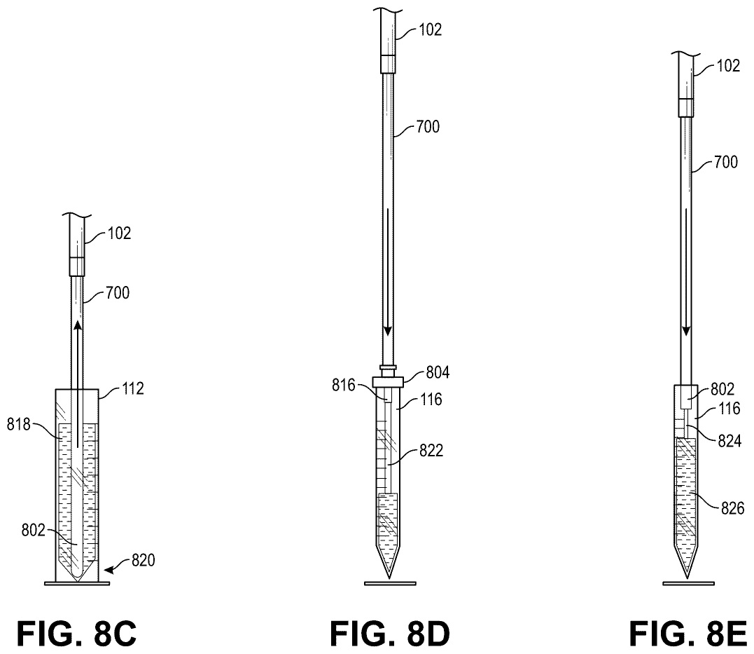

Referring to FIGS. 1 through 26, an automated filtration system (“system 100”) is shown, with FIGS. 1 through 6 illustrating aspects of the system 100 for drawing filtered sample into a sample line, removing the filter after filtering the sample, and dispensing the filtered sample is shown in accordance with an example embodiment of the present disclosure, and with FIGS. 7 through 26 illustrating aspects of the system 100 for automatically uncapping sample containers for access to a sample probe with subsequent attachment of a filter or with the filter having an integrated sample probe. The system 100 generally includes an autosampler having an autosampler arm (“autosampler arm 102”) configured to attach with a filter having an integrated probe (“filter probe 104”) or a probe configured to attach a filter to a bottom end of the probe (e.g., shown with respect to FIGS. 8A and 8B). For instance, the probe can be a generally tubular structure having sufficient length to be inserted into an interior volume of a sample container and receive fluid through the tubular structure. The filter of the filter probe 104 can include, but is not limited to, micron-scale pores to filter samples for analytical determination of chemical composition of the fluid without substantial solid particulates present in the fluid. The filter probe 104 is fluidically coupled with a sample fluid line 106 (e.g., shown in FIG. 3B) to receive fluid from the filter probe 104 through action of a pump, vacuum source, or other negative pressure system (“pump/vacuum source 108”) fluidically coupled with the sample fluid line 106.

The autosampler arm 102 is configured to interact with containers 110 of the system 100, either directly or via the filter probe 104, to withdraw samples from the containers 100, to introduce filtered samples into the containers, to introduce other fluids into the containers, or the like. In implementations, the containers 110 are positioned on a deck of the autosampler, such through support by a sample rack or other support structure. The containers 110 can include, for example, one or more sample vials, sample tubes, wells of a microtiter plate, or other fluid containers or combinations thereof. In implementations, the containers 110 include sample containers 112 containing unfiltered liquid samples for analysis, filtered sample containers 114 configured to receive filtered sample (e.g., filtrate) that was drawn through the filter probe 104 and into the sample fluid line 106, and prepared filtered sample containers 116 configured to receive portions of filtered sample for further sample preparation, such as by adding diluent, internal standard, reactive chemicals, or the like, or combinations thereof.

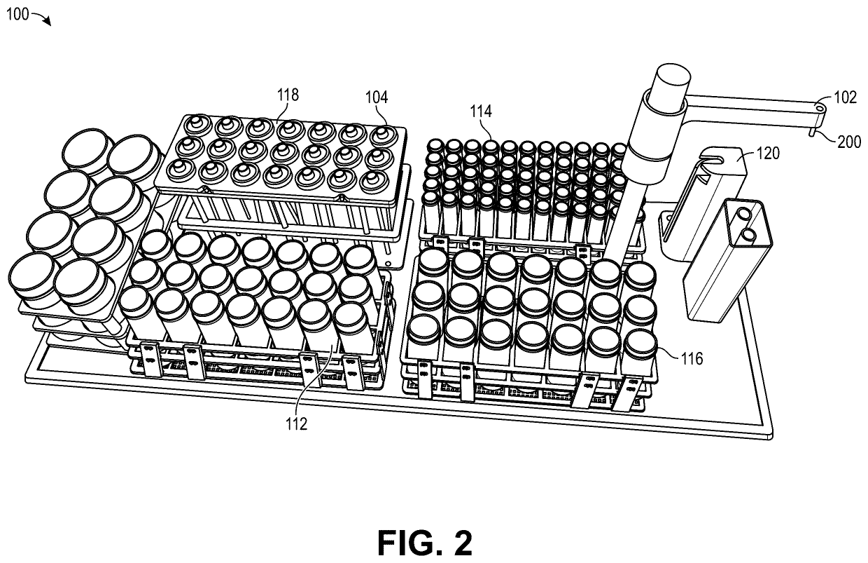

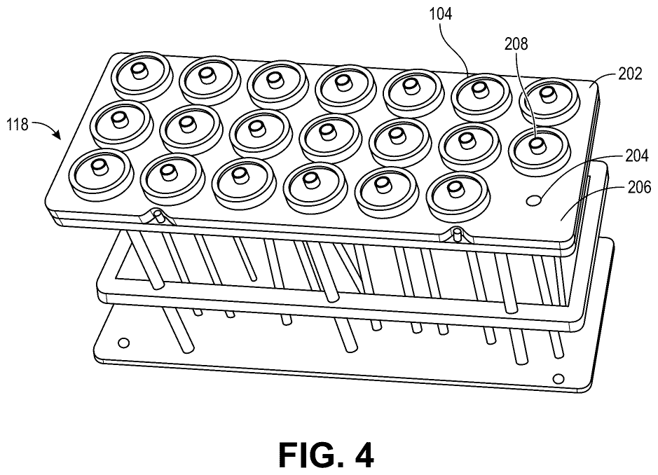

The system 100 is also shown including a filter probe storage 118 and a filter retainer 120. The filter probe storage 118 includes a plurality of filter probes 104 for interaction with the autosampler arm to connect a filter probe 104 to an end 200 of the autosampler arm 102 (e.g., shown in FIG. 2). An example filter probe storage 118 is shown in FIGS. 2 and 4. In implementations, the filter probe storage 118 includes a rack 202 having a plurality of apertures 204 through a top surface 206 of the rack 202. Probes of the filter probes 104 can be inserted into the aperture 204 to rest the filter of the filter probe 104 against the top surface 206. During operation, in preparation to draw an unfiltered sample, the autosampler arm 102 can position the end 200 over a filter probe 104 and lower the autosampler arm 102 until the end 200 is secured within an end 208 of the filter probe 104. A secured configuration between the end 200 of the autosampler arm 102 and the end 208 of the filter probe 104 is shown in FIG. 3B.

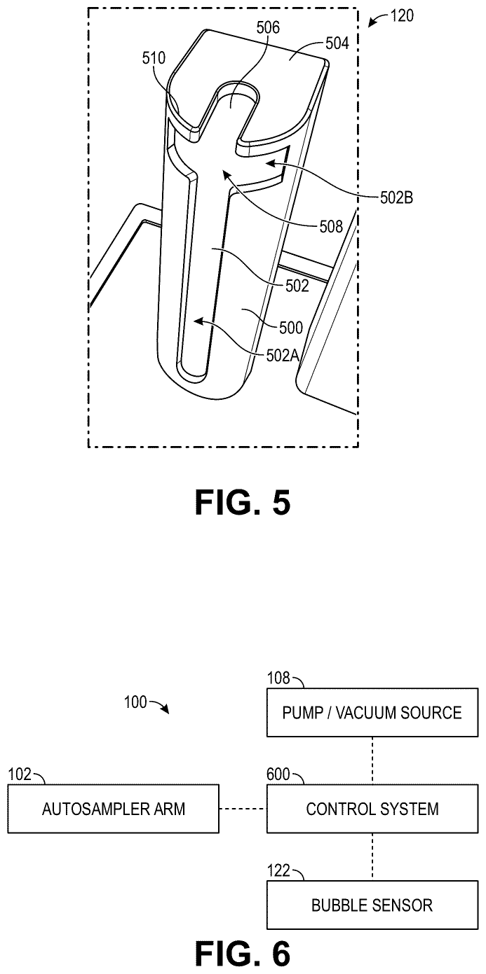

Referring to FIG. 5, the filter retainer 120 facilitates removal of the filter probe 104 from the end 200 of the autosampler arm 102, such as to remove the filter probe 104 following passage of the sample fluid through the filter. Alternatively or additionally, the filter retainer 120 facilitates removal of a filter from an end of a sample probe following dispensing of the filtrate from the sample probe (e.g., the sample probe described herein with respect to FIG. 8A). The filter retainer 120 is shown including a shield 500 defining a front aperture 502 and a top portion 504 coupled with the shield 500, where the top portion 504 defines a top aperture 506. The front aperture 502 is configured to permit the filter probe 104 to pass through the shield 500 and into an interior region 508 of the filter retainer 120 defined by the shield 500. For example, the front aperture 502 can include a first portion 502A configured to conform to the generally tubular shape of the probe of the filter probe 104 and can include a second portion 502B configured to conform to a generally disk-shaped filter of the filter probe 104 to permit the filter probe 104 to pass through the shield 500. In implementations, the top aperture 506 extends to a front end 510 of the top portion 504 to intersect with the front aperture 502 to permit the end 200 of the autosampler arm to pass through the top aperture 506 when maneuvering to position the filter probe 104 through the front aperture 502 of the shield 500 and into the interior region 508. Such a configuration of apertures can also facilitate removal of a filter from a bottom end of a sample probe, such as the sample probe described herein with respect to FIG. 8A. When the system 100 is ready to remove the filter probe 104, the autosampler arm 102 can lift vertically relative to the filter retainer 120 where the top portion 504 pushes against the filter of the filter probe 104 until the filter probe 104 is pulled from the end 200 of the autosampler arm 102. In implementations, the filter retainer 120 includes a chute to pass the removed filter probe 104 into a waste container to maintain the filter retainer 120 in a ready state to receive another filter probe 104.

In implementations, the system 100 can include a sensor to control operation of one or more functions. For example, referring to FIGS. 1, 6, and 7, the system 100 is shown including a bubble sensor 122 positioned relative to the sample fluid line 106 and/or the filter probe 104 to detect that liquid is flowing through the filter probe 104. The bubble sensor 122 can include, for example, one or more optical sensors, pressure sensors, ultrasonic transducers, conductivity sensors, or other sensors, and combinations thereof. If one or more bubbles are sensed by the bubble sensor 122, the system 100 can reduce the rate of filtering (e.g., by controlling operation of the pump/vacuum source 108) to control the rate of filtrate production, such as to minimize the amount of bubbles in the filtrate within the sample fluid line 106. For example, the bubble sensor 122 can output a sense signal to a control system 600 communicatively coupled with the bubble sensor 122 and the pump/vacuum source 108. Upon receipt of a sense signal indicative of the presence of bubbles that exceed a threshold bubble amount, the control system 600 can transmit one or more control signals to the pump/vacuum source 108 to reduce the rate at which sample is drawn through the filter probe 104. In implementations, the control system 600 utilizes a feedback loop to maintain a desired flow rate of sample through the filter probe 104 while maintaining bubbles within the filtrate below a threshold value. The control system 600 can also be communicatively coupled with the autosampler arm 102 to control positioning of the autosampler arm 102 via motor control, such as to move the autosampler arm 102 between the filter probe storage 118, the containers 110, and the filter retainer 120, or relative to other components of the system 100 described herein.

Referring generally to FIGS. 1-6, an example filtration process includes positioning the end 200 of the autosampler arm 102 (e.g., via motor control by the control system 600) above a filter probe 104 held by the filter probe storage 118. In implementations, the control system 600 can execute software protocols to track availability of the particular positions of the filter probe storage 118 and the containers 110 to facilitate proper sample container locations for sample withdrawal and filtered sample deposit. The autosampler arm 102 then lowers onto the filter probe 104 to connect the end 200 of the autosampler arm 102 with the end 208 of the filter probe 104. The autosampler arm 102 then raises the filter probe 104 from the filter probe storage 118 and positions the probe of the filter probe 104 above the next sample for filtration present in the sample containers 112.

The autosampler arm 102 then lowers the probe into the appropriate sample container 112, where the pump/vacuum source 108 operates to draw a sample into the probe and through the filter of the filter probe 104, introducing filtered sample into the sample fluid line 106. In implementations, the only sample fluids that enter the sample fluid line 106 are filtered samples that passed through the filter of the filter probe 104. When the appropriate amount of sample is received through the filter probe 104 (e.g., determined via mass flow controller, timer, pump speed, etc., or combinations thereof), the system 100 positions the autosampler arm 102 to introduce the filter probe 104 to the filter retainer 120. For instance, the filter probe 104 is introduced through the front aperture 502 and the autosampler arm 102 is raised to retain the filter probe 104 within the interior region 508. By removing the filter probe 104, the autosampler arm can dispense filtered sample through the end 200 (e.g., via operation of the pump 108) without having the filtered sample pass through the filter of the filter probe 104, thereby avoiding reintroduction of filtered particulates maintained in the filter probe 104 back into the filtrate during the dispensing procedure.

The autosampler arm 102 can be fitted with a separate dispensing probe or can directly dispense the filtered sample into the appropriate filtered sample container 114. For samples that are to be further prepared prior to analytical determination, the samples can be transferred from the filtered sample container 114 to the appropriate prepared filtered sample container 116 for introduction of one or more additional fluids (e.g., diluent, internal standard, reaction chemical, or the like, or combinations thereof), however it is contemplated that such sample preparation could also be facilitated directly in the filtered sample container 114 without transfer to a separate container. Alternatively or additionally, the system 100 can operate to draw an unfiltered sample into the sample fluid line 106, then connect the filter probe 104 onto the autosampler arm 102 for dispensing of a filtered sample into the filtered sample container 114.

The system 100 can operate to prepare a single sample for analysis by filtering the sample, dispensing the filtered sample into the filtered sample container 114, and then optionally further preparing the sample for analysis through addition of one or more additional fluids with the sample (e.g., in filtered sample container 114 or prepared filtered sample container 116). The system 100 can also operate to filter a plurality of samples by filtering the samples and depositing the samples into individual filtered sample containers 114 prior to facilitating any further addition of fluids to the filtered samples. Alternatively or additionally, groups of samples can be handled individually to individually filter samples and add fluid(s) to the filtered sample individually before proceeding to the next sample, whereas other groups of samples can be handled to filter the group before adding further fluids to the filtered samples from the group. In implementations, the control system 600 facilitates sample preparation, such as by facilitating the order of samples processed, the desired end volume of samples, the standard type added to the sample, the number of samples processed from a filtered sample, or the like, or combinations thereof.

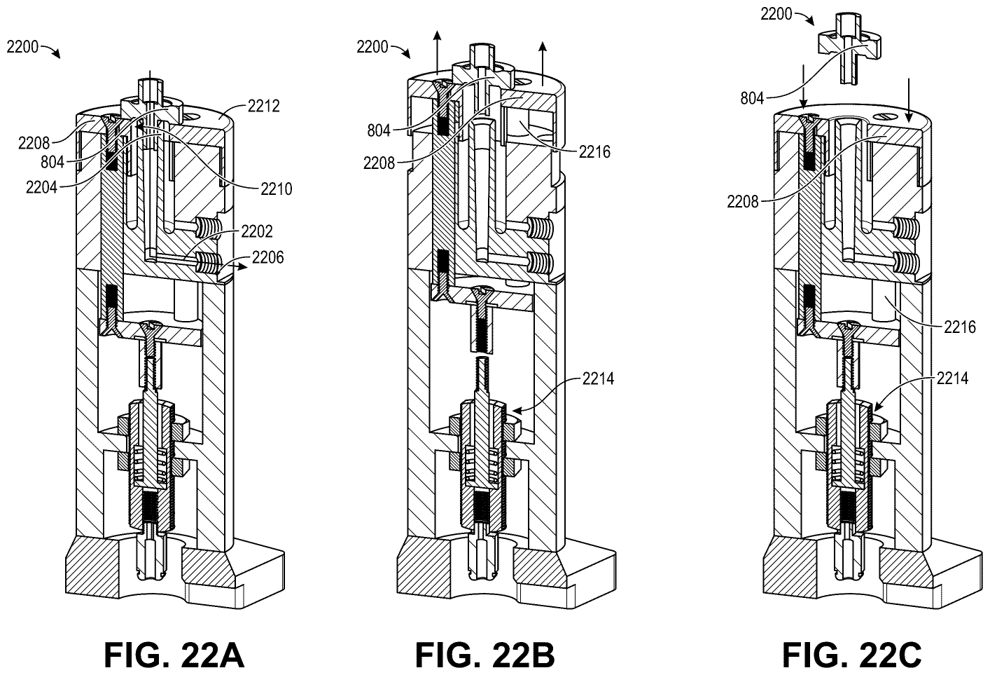

Referring to FIG. 7, the system 100 is shown having a probe 700 coupled with the autosampler arm 102 and configured to receive a filter from a filter storage 702 onto a bottom end of the probe 700 following introduction of a sample into the probe 700 and/or the sample fluid line 106 attached to the probe. An example of the probe 700 is shown in FIGS. 8A and 8B having a top end 800 configured to secure to the autosampler arm 102 (e.g., via screw fit arrangement) and a bottom end 802 configured to secure to a filter 804. The bottom end 802 can have a tapered outer surface 806 that tapers inward towards an inner fluid channel 808 as the probe 700 extends from the top end 800 to the bottom end 802 to facilitate placement of the bottom end 802 of the probe 700 into a top port 810 of the filter 804. In implementations, the tapered outer surface 806 includes a chamfer 812 at the distal portion of the bottom end 802 to provide a range of alignment paths (e.g., an alignment path 814 is shown in FIG. 8B) to insert the bottom end 802 into the top port 810 of the filter 804. For example, during operation of the system 100, the probe 700 is inserted into the sample container 112, sample is drawn into the probe 700 through action of the pump/vacuum source 108, and the autosampler arm 102 then positions the probe above the filter storage 702 to introduce the filter 804 onto the bottom end 802 of the probe 700. Following attachment of the filter 804 to the probe 700, the autosampler arm 102 can reposition the probe 700 to move the filter 804 to a predetermined location for dispensing of the filtrate, including but not limited to, the sample container 112, a separate fluid container (e.g., the filtered sample container 114, the prepared filtered sample container 116), a sample port in fluid communication with the sample analysis system 704, or the like, or combinations thereof. For example, the autosampler arm 102 can position the probe 700 to place a bottom port 816 of the filter 806 into contact with a sample port fluidically coupled with a sample preparation system and/or a sample analysis system (e.g., sample analysis system 704 shown in FIG. 7), examples of which are described herein with respect to FIGS. 22A through 25B.

In implementations, the filter 804 includes a bottom port 816 through which the filtrate is dispensed, where the bottom port 816 can be positioned above a fluid container to dispense the filtrate into the fluid container, positioned to interface with a sample port fluidically coupled with a sample preparation system and/or a sample analysis system (e.g., sample analysis system 704 shown in FIG. 7), or combinations thereof. For example, the autosampler arm 102 can position the probe 700 to place the bottom port 816 of the filter 804 over a fluid container to dispense filtrate into the fluid container and to introduce one or more additional fluids or chemicals to the filtrate, such as to add diluent, internal standard, reactant chemicals, or the like, or combinations thereof, to prepare the filtrate for sample analysis. An example is shown with respect to FIGS. 8C through 8E, where the autosampler arm 102 is shown in FIG. 8C positioning the probe 700 within the sample container 112 to draw sample fluid 818 from the sample container 112 into the probe (e.g., through action of the pump/vacuum source 108). In implementations, the autosampler arm 102 introduces the bottom end 802 of the probe 700 to a bottom end 820 of the sample container 112, such as to ensure that no bubbles are drawn into the probe 700 during the sample drawing process. For instance, the bottom end 802 of the probe 700 can be positioned within the bottom 5% to 20% of the height of the sample container 112 measured from the bottom of the sample container 112. In implementations, the probe 700 has a length of about 8 inches, however other lengths can be utilized without departing from the scope of the present disclosure, such as lengths less than 8 inches or length more than 8 inches, to facilitate fluid transfer with differing heights of sample containers.

Referring to FIG. 8D, the probe 700 is shown holding the sample fluid 818 and having the filter 804 secured to the bottom end 802. For instance, the autosampler arm 102 can move the probe 700 to the filter storage 702 to insert the bottom end 802 into the top port 810 of the filter 804. The autosampler arm 102 is shown having positioned the probe 700 with the filter 804 to a second container (e.g., the prepared filtered sample container 116) to inject filtrate 822 into the second container through the bottom port 816 of the filter 804. Alternatively or additionally the second container can be brought underneath the probe 700, such as through action of the container placement system 706, the rotary uncapper 708, or other container movement device. Referring to FIG. 8E, the probe 700 is shown with the filter 700 having been removed (e.g., through interaction of the autosampler arm 102 and filter 804 with the filter retainer 120). The probe 700 is positioned such that the bottom end 802 can introduce another fluid 824 (e.g., an internal standard, a diluent, a reactant, etc.) into the second container to mix with the filtrate 822 to provide a prepared filtrate 826 for analysis.

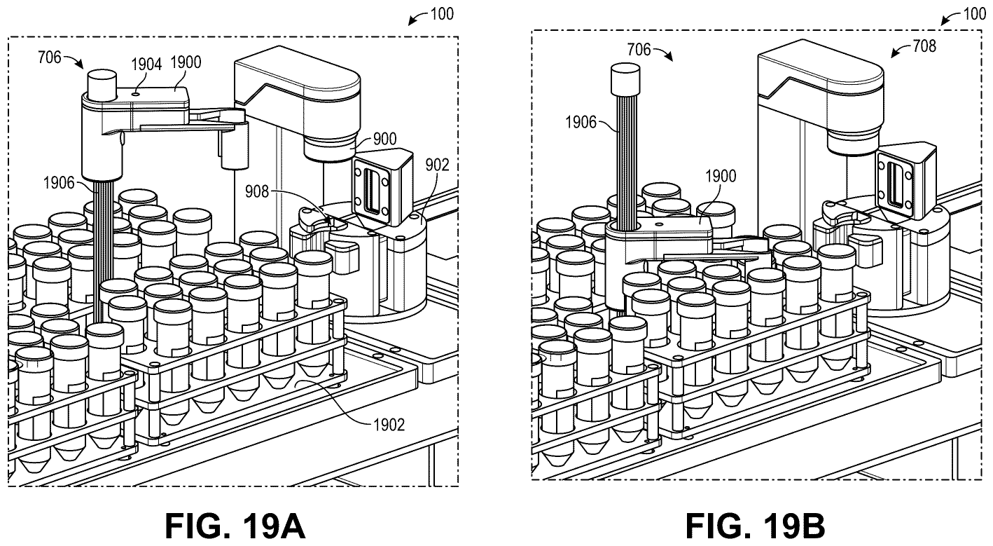

Referring again to FIG. 7, the system 100 is shown including a container placement system 706 and a rotary uncapper 708 that coordinate operations to provide the sample container 112 in an uncapped state to receive the probe 700 (and/or the filter probe 104) to draw sample from the sample container 112 into the probe 700 for filtering. The container placement system 706 is generally configured to move a sample container 112 from a first location, such as a sample rack on a laboratory bench, to the rotary uncapper 708 for removal of any caps, lids, septums, or the like, on the sample container 112 to make the interior of the sample container 112 available for access by the probe 700. An example container placement system 706 is described further herein with reference to FIGS. 19A through 21B.

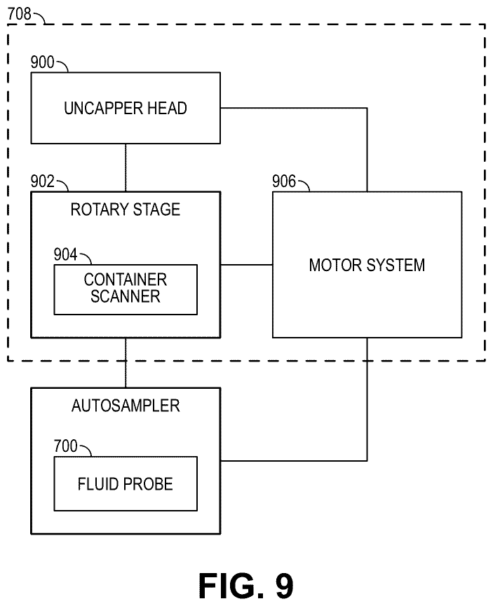

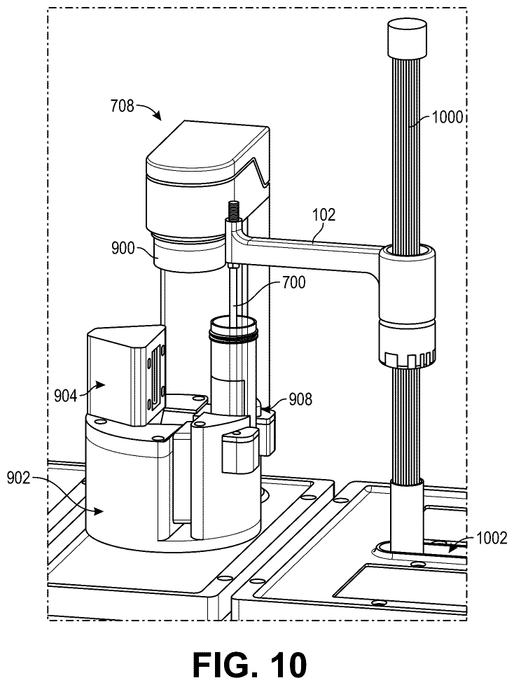

An example rotary uncapper 708 is shown in FIGS. 9 through 18B. For instance, referring to FIG. 9, the rotary uncapper 708 is shown diagrammatically including an uncapper head 900, a rotary stage 902, a container scanner 904, and a motor system 906 operably coupled to the uncapper head 900 and the rotary stage 902 to drive rotational and/or vertical motion of the uncapper head 900 and the rotary stage 902 to facilitate uncapping and repositioning of the sample container 112 for access by the fluid probe 700. The rotary uncapper 708 is shown in FIG. 10 with an open/uncapped sample container 112 with the probe 700 inserted therein and with the probe 700 being supported by the autosampler arm 102 coupled with a support 1000 configured to translate through a slot 1002 in an autosampler deck (e.g., via action of a motor (not shown)).

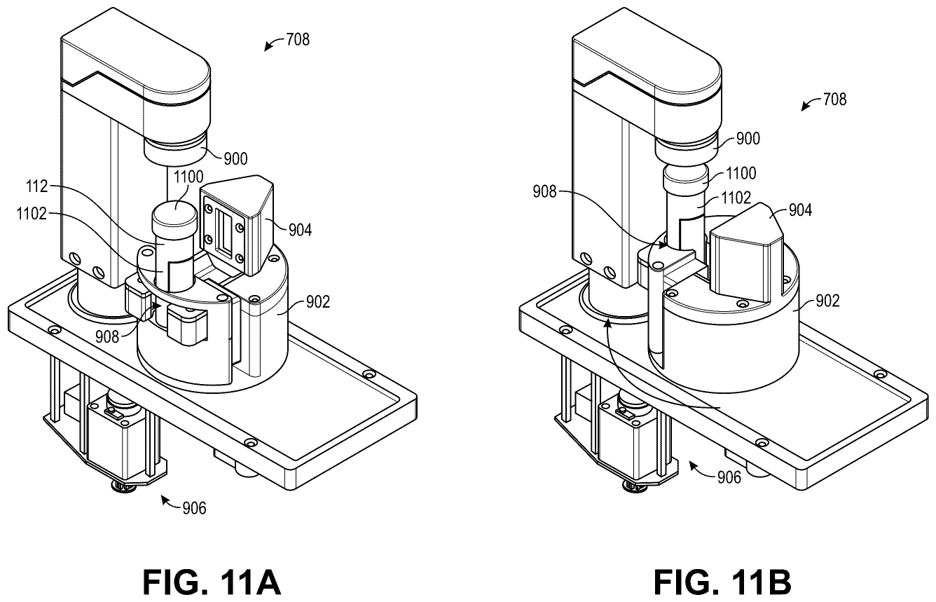

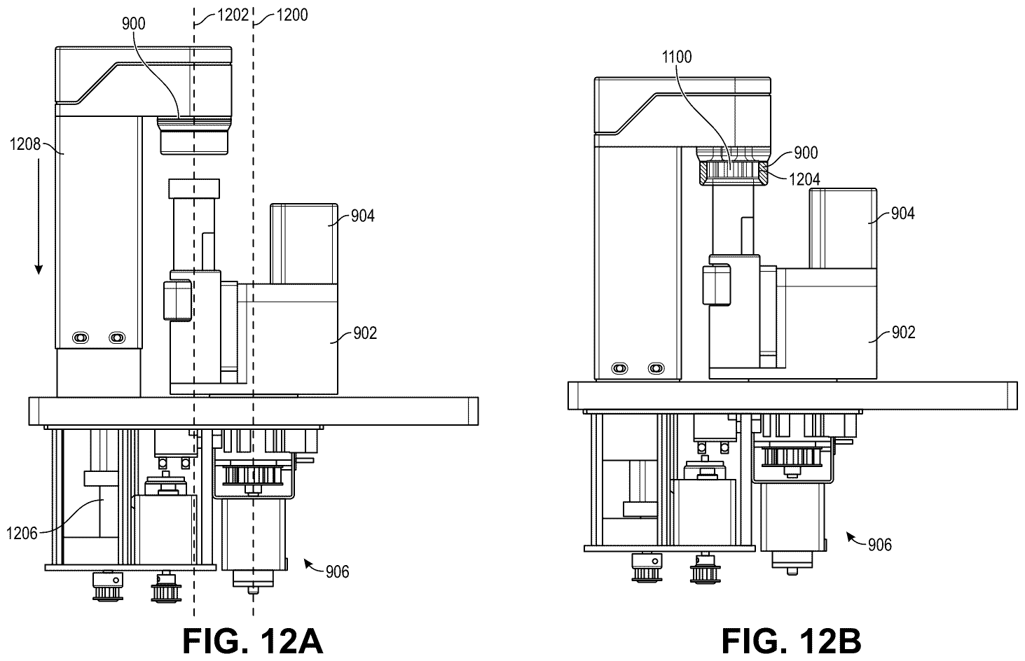

Referring to FIGS. 11A and 11B, the rotary stage 902 can begin with a fluid container 112 held in a container aperture 908 rotated in any position (e.g., 360 degrees of rotation about a vertical axis, such a first axis 1200 shown in FIG. 12A) and then subsequently moves the fluid container 112 (e.g., via action by the motor system 906) beneath the uncapper head 900 in preparation for removal of a cap 1100 positioned on a sample container base 1102. In implementations, the fluid container 112 can be placed in the container aperture 908 automatically through action of the container placement system 706, described further herein.

Referring to FIG. 12A, the rotary uncapper 708 is shown moving the uncapper head 900 axially along a second axis 1202 to interact with the removable cap 1100 of the fluid container 112. For example, the rotary uncapper 708 can transition the uncapper head 900 between a raised configuration (e.g., shown in FIG. 12A) and a lowered configuration (e.g., shown in FIG. 12B) axially along the second axis 1202 to bring the uncapper head 900 into contact with the cap 1100 in the lowered configuration For instance, referring to FIG. 12B, the uncapper head 900 is shown surrounding the cap 1100, with an interior surface 1204 of the uncapper head 900 interfacing with the cap 1100 to provide structural interaction such that rotation of the uncapper head about the second axis 1202 drives rotation of the cap 1100 about the second axis 1202. In implementations, the rotary uncapper 708 detects the location of the fluid container 112 as the proper location for uncapping based on motor/encoder feedback. For instance, when the rotary uncapper 708 detects that the fluid container 112 is rotated about the first axis 1200 through action of the motor system 906 on the rotary stage 902 and is determined to be underneath the uncapper head 900 based on motor/encoder feedback, the motor system 906 can cause the uncapper head 900 to be lowered axially along the second axis 1202 into position surrounding the cap 1100 for removal. In implementations, the motor system 906 includes a lifting rod 1206 coupled with an uncapper head housing 1208 that supports the uncapper head 900 above the rotary stage 902. Upon activation or deactivation of the lifting rod 1206, the motor system 906 can move the uncapper head 900 axially along the second axis 1202.

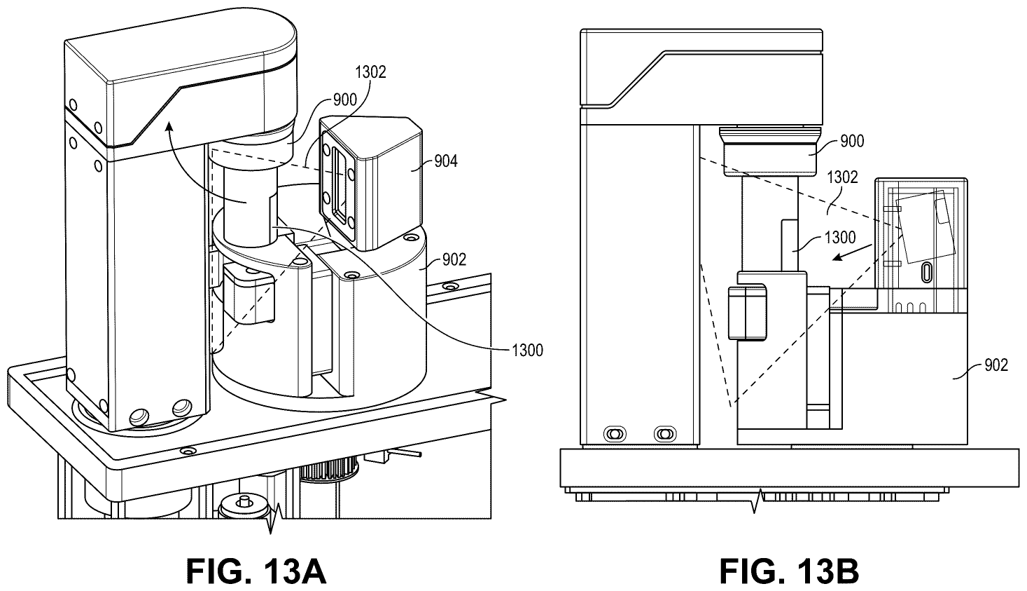

The rotary uncapper 708 is configured to reposition the fluid container 112 as needed to bring a label 1300 into a scanning area 1302 of the container scanner 904 to provide the system 100 with information about the fluid container 112, the sample held therein, analyses to be performed on the sample, and the like, and combinations thereof. The label 1300 can include, but is not limited to, an image, a barcode (e.g., 2D barcode, matrix barcode, etc.), characters for character recognition, or the like, or combinations thereof. For example, referring to FIGS. 13A and 13B, the uncapper head 900 is configured to rotate the fluid container 112 in a close/tightening direction (e.g., clockwise about the second axis 1202) to permit the container scanner 904 to bring the label 1300 into the scanning area 1302 of the container scanner 904 to permit the container scanner 904 to scan the label 1300 and generate a sense signal. The identifying information on the label 1300 can correspond to a table that stores the label identifying information with the corresponding information about the fluid container 112, the sample held therein, analyses to be performed on the sample, and the like, and combinations thereof.

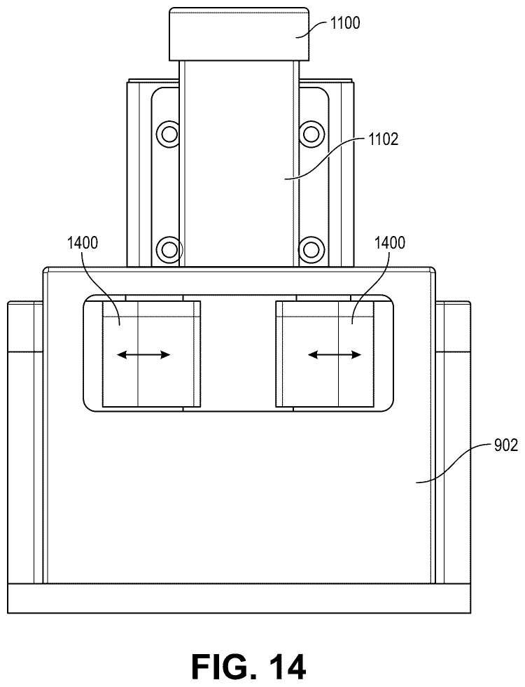

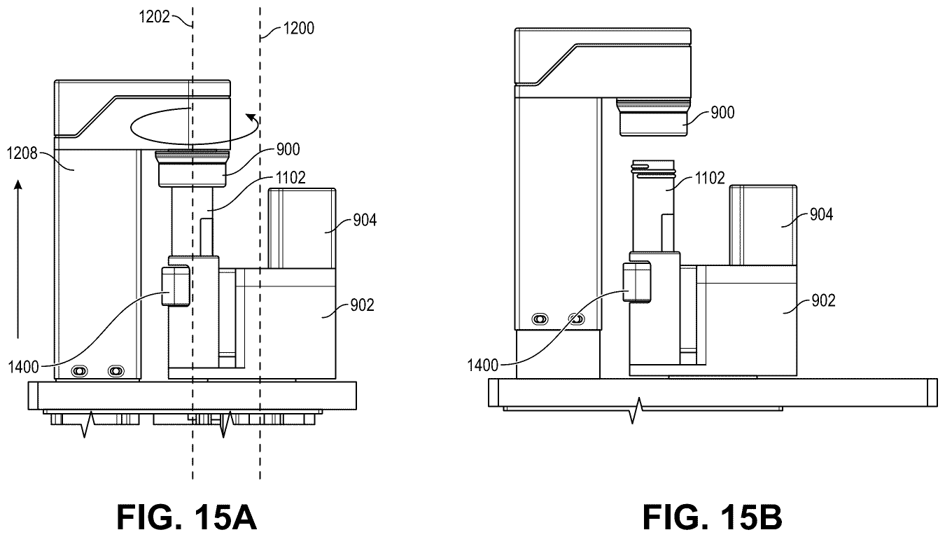

The rotary uncapper 708 can facilitate manipulating the fluid container 112 within the container aperture 908 to assist with removal and replacement of the cap 1100 on the sample container base 1102, such as to hold the sample container base 1102 stationary or to counter-rotate the sample container base 1102 during cap removal and replacement. For example, referring to FIG. 14, the rotary stage 902 is shown including grippers 1400 positioned adjacent the container aperture 908. The grippers 1400 moveably engage and disengage with the sample container base 1102 (e.g., under control by the motor system 906) to permit or prevent rotation or vertical movement of the fluid container 112 during operation of the system 100. An example cap removal operation is shown with respect to FIGS. 15A and 15B, where the fluid container 112 is shown secured by the grippers 1400 to prevent rotation of the sample container base 1102 and with the uncapper head 900 rotabably removing the cap 1100 with each of an upward motion (e.g., axially along the second axis 1202, through motion of the uncapper head housing 1208) and a rotational motion (e.g., rotating around the second axis 1202), holding the cap 1100 within the uncapper head 900. In implementations, the rate of rotation and lifting of the uncapper 900 head matches the pitch of the threading on the sample container base 1102 and cap 1100.

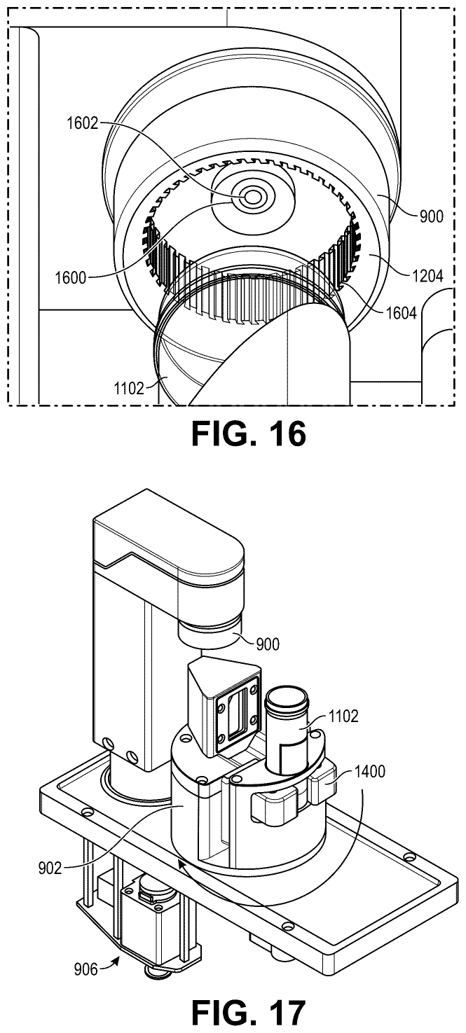

Referring to FIG. 16, an example of the uncapper head 900 of the rotary uncapper 708 is shown including a suction cup 1600 within an area bounded by the interior surface 1204 of the uncapper head 900 to hold the cap 1100 in place within the uncapper head 900 while raised above the sample container base 1102. For example, the suction cup 1600 can include a vacuum port 1602 fluidically coupled with a vacuum source (e.g., the pump/vacuum source 108) to assist with holding the cap 1100 in place within the uncapper head 900. The operation of the vacuum can be coordinated with rotation of the uncapper head 900 such that the vacuum is engaged during rotation to secure the cap 1100 during vertical cap removal and disengaged following rotation of the cap during replacement of the cap 1100 onto the sample container base 1102. In implementations, the uncapper head includes a rigid end effector that is machined or otherwise constructed to match the profile of the cap. For example, the interior surface 1204 can include protrusions 1604 that complement protrusions (e.g., can be positioned between grooves formed by the protrusions) on an exterior surface of the cap 1100 to provide interlocking structures between the uncapper head 900 and the cap 1100 to assist with rotating the cap 1100 during rotational operation of the uncapper head 900.

Following uncapping of the fluid container 112, the rotary uncapper 708 can reposition the uncapped sample container base 1102 to provide access to the sample contained therein to the fluid probe of the autosampler (e.g., probe 700, filter probe 104, etc.). For example, referring to FIG. 8, the rotary stage 902 is shown having repositioned the sample container base 1102 from underneath the uncapper head 900 to a position approximately 180 degrees rotated about the first axis 1200, such as to be accessible by a fluid probe of the autosampler. In implementations, the rotary stage 902 can rotate 360 degrees about the first axis 1200 to reposition the fluid container 112 amongst a variety of positions.

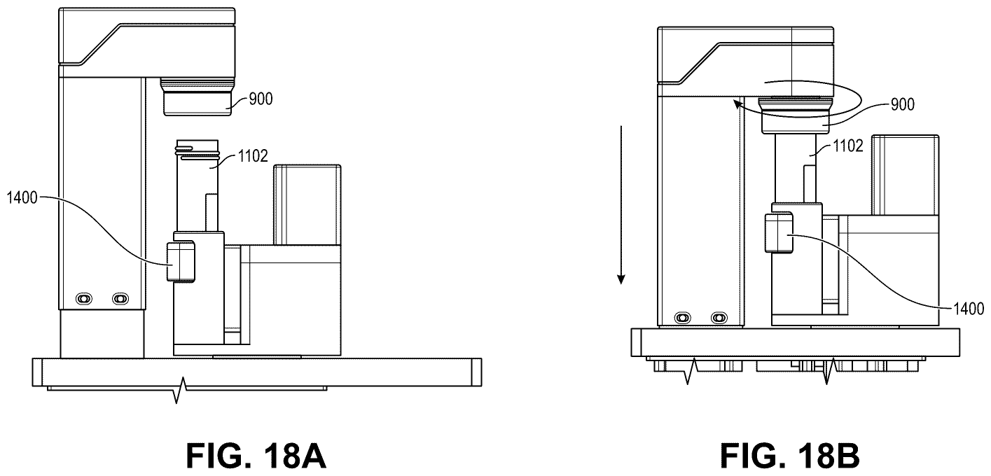

The rotary uncapper 708 can also replace the cap 1100 onto the sample container base 1102, such as following removal of sample by the fluid probe. Replacement of the cap 1100 can preserve remaining sample within the fluid container 112, such as if replicate sample analysis is desired. For example, referring to FIGS. 18A and 18B, the cap 1100 is shown held by the uncapper head 900 (e.g., under vacuum by the suction cup 1600) in preparation to replace the cap 1100 back onto the sample container base 1102 and subsequently lowered (e.g., along the second axis 1202) and rotated (e.g., about the second axis 1202) by the uncapper head 900 to replace the cap 1100 onto the sample container base 1102 while the grippers 1400 hold the sample container base 1102 stationary. In implementations, the rate of rotation and descent of the uncapper head 900 matches the pitch of the threading on the sample container base 1102 and cap 1100. In implementations, rotation of the cap 1100 is torque-controlled by the motor system 908 to prevent over-or under-rotation.

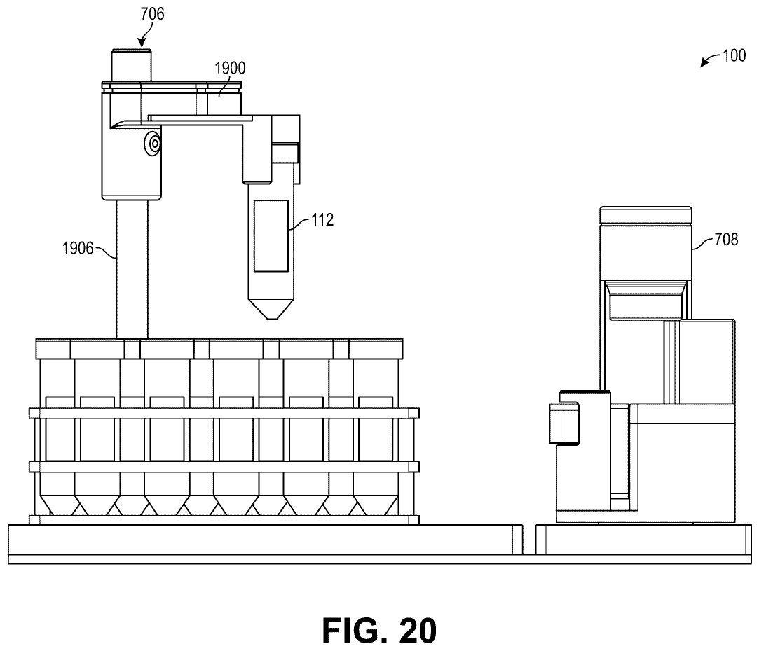

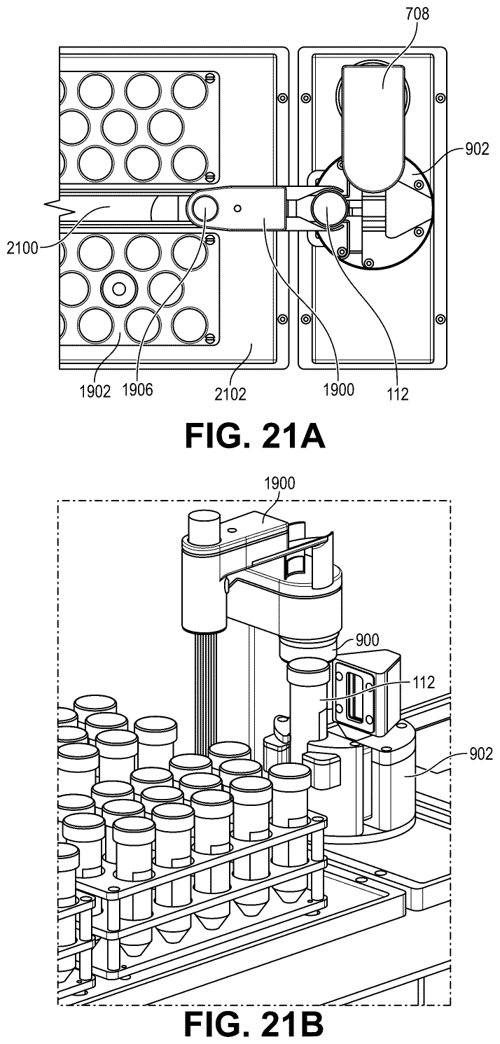

The system 100 can facilitate automatic placement of the fluid container 112 into the container aperture 908 of the rotary uncapper 708 according to any suitable mechanism. For example, the system 100 is shown in FIGS. 19A through 21B including the container placement system 706 having a container gripper 1900 configured to move above a specific fluid container 112 (e.g., from a sample rack 1902, shown in FIG. 19A), position the container gripper 1900 around the fluid container 112 (e.g., shown in FIG. 19B), lift the fluid container 112 (e.g., shown in FIG. 20), reposition the fluid container 112 above container aperture 908 of the rotary uncapper 708 (e.g., shown in FIG. 21A), and set the fluid container 112 within the container aperture 908 (e.g., shown in FIG. 21B). In implementations, the container gripper 1900 includes pneumatically-powered tongs that close and open responsive to application or removal of a pneumatic fluid (e.g., air, inert gas, etc.) introduced to an inlet port 1904 of the container gripper 1900. In implementations, the container gripper 1900 is supported by a support rod 1906 coupled with a motor system to move the container gripper 1900 through translational movement of the support rod 1906 (e.g., along a slot 2100 in an autosampler deck 2102 supporting the sample rack 1902), vertical movement of the container gripper 1900 along the support rod 1906, and rotational movement of the container gripper 1900 about an axis defined by the support rod 1906 to permit the container gripper 1900 to access any fluid container 112 in the sample rack 1902 and move the respective containers to the rotary uncapper 708.

Once the system 100 has drawn a fluid sample into the probe of the autosampler, the filtrate can be directed to one or more locations for sample preparation, sample analysis, or combinations thereof. For example, the filtrate prepared by the filter probe 104 or from transfer out of the filter 804 via the probe 800 can be introduced to a collection tube (e.g., another sample container base 1102) for introduction of one or more additional fluids. For instance, the system can introduce, through the probe 800 or another probe, one or more diluents, internal standard solutions, reagents, or combinations thereof, to the filtrate held in the collection tube. In implementations, the system 100 facilitates mixing of the filtrate with one or more mixing techniques including, but not limited to, magnetic stir plates and bars, introduction of bubbles via the probe 800 or another probe (e.g., as described in U.S. patent application Ser. Nos. 12,881,906 and 17/091,581, which are incorporated by reference herein), or combinations thereof.

Referring to FIGS. 22A through 26, the system 100 can direct the filtrate to a sample line for analysis by an analysis system, with or without additional sample preparation for the filtrate. For example, the system 100 is shown introducing the bottom port 816 of the filter 804 to a filter disengagement system 2200, which can be coupled with the filter retainer 120 or separate therefrom, to introduce filtrate received from the filter 804 (e.g., via sample supplied through the probe 700 to the top port 810 of the filter 804, not shown) to a sample fluid line 2202 for subsequent transfer from the filter disengagement system 2200 (e.g., for further sample preparation or for sample analysis, as described herein). For instance, the filter disengagement system 2200 is shown with the bottom port 816 of the filter 804 introduced to, and coupled with, a sample port 2204 configured to receive the filtrate from the filter 804 (e.g., through pushing of the sample through the probe 700 and into the filter 804, via action of the pump/vacuum source 108). The sample port 2204 is fluidically coupled with the sample fluid line 2202 to direct the filtrate received from the filter 804 into the sample fluid line 2202 to carry the filtrate from the filter disengagement system 2200 (e.g., via a sample outlet port 2206).

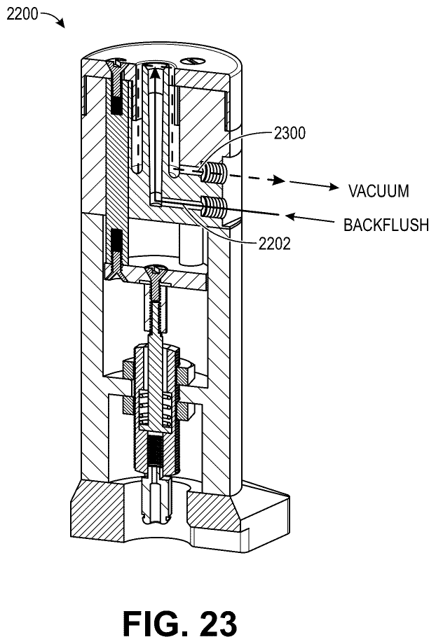

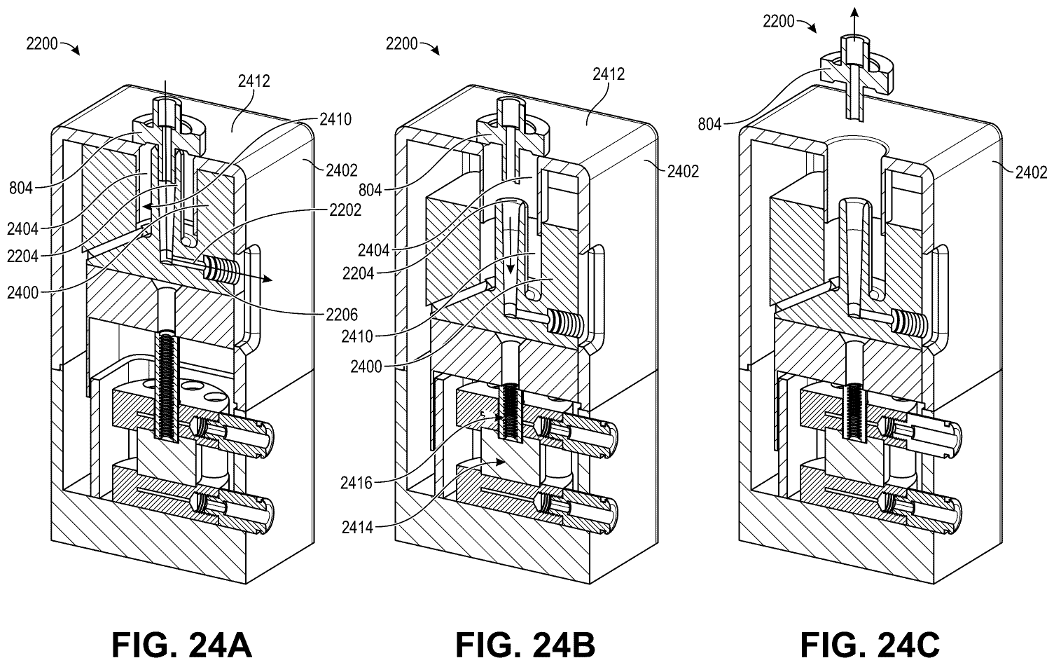

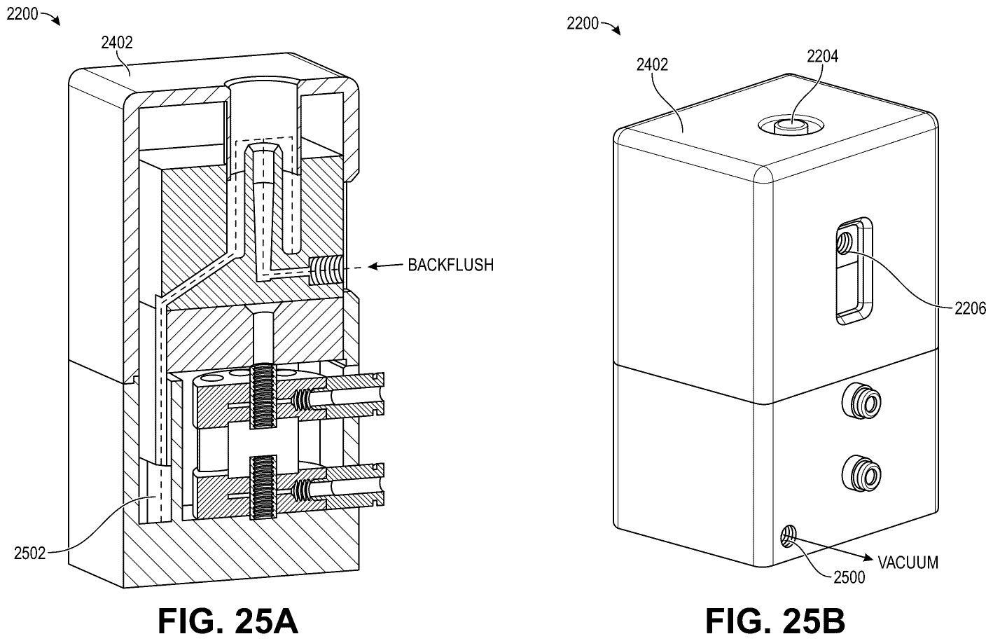

Since the filter 804 is inserted into the sample port 2204 with sufficient force to prevent splashing of sample or dislodging the filter 804, the filter disengagement system 2200 can include one or more systems to disengage the filter 804 from the sample port 2204, such as to prevent the bottom port 816 of the filter 804 from sticking within the sample port 2204 following filtrate transfer. For instance, the bottom port 816 of the filter 804 can be introduced to the sample port 2204 with sufficient force to prevent spraying of the filtrate out from an area between the bottom port 816 and the sample port 2204, however friction fit between the bottom port 816 and the sample port 2204 can cause the filter 804 to become stuck, where attempting to move the probe 700 away from the sample port following filtrate transfer could otherwise pull the probe 700 from the filter 804, leaving the filter 804 attached to the sample port 2204. For example, the filter disengagement system 2200 is shown in FIGS. 22A through 23 having a disengagement structure to push the filter 804 away from the sample port 2204 following filtrate transfer, and is shown in FIGS. 24A through 25B having a disengagement structure to pull the sample port 2204 away from the filter 804 following filtrate transfer.

Referring to FIG. 22A, the filter disengagement system 2200 is shown with the bottom port 816 of the filter 804 inserted within the sample port 2204. The filter disengagement system 2200 includes a disengagement structure 2208 defining an aperture 2210 in which the sample port 2204 resides when the disengagement structure 2208 is in an engaged configuration. For instance, when the disengagement structure 2208 is in the engaged configuration, a bottom surface of the filter 804 can rest against a top surface 2212 of the disengagement structure 2208 while the bottom port 816 is positioned within the sample port 2204. In implementations, the sample port 2204 is substantially level with the top surface 2212 of the disengagement structure 2208 when the disengagement structure 2208 is in the engaged configuration.

Referring to FIG. 22B, the filter disengagement system 2200 is shown disengaging the filter 804 from the sample port 2204 by pushing the disengagement structure 2208 outwards away from the sample port 2204 which in turn pushes the bottom surface of the filter 804 away from the sample port 2204. In implementations, the filter disengagement system 2200 includes a motor system 2214 coupled with the disengagement structure 2208 via a rod 2216 whereby extension of the rod 2216 upwards causes a proportional movement upwards of the disengagement structure 2208. Referring to FIG. 22C, the filter disengagement system 2200 is shown with the disengagement structure 2208 reset into the engaged configuration, but with the filter 804 pulled away from the filter disengagement system 2200, such as through action by the autosampler arm 102 pulling the probe 700 away from the filter disengagement system 2200. In implementations, the filter 804 can then be separated from the probe 700 via the filter retainer 120, such as in preparation to affix a new filter 804 onto the probe 700 for subsequent sample handling.

The filter disengagement system 2200 can facilitate rinsing of the internal fluid passages, such as to rinse any residual fluids within or around the sample port 2204, the sample fluid line 2202, or the like, prior to introduction of a filtrate from a subsequent sample. For example, FIG. 23 shows introduction of a rinse fluid into the sample outlet port 2206 for passage into the sample fluid line 2202 to backflush the rinse fluid into the aperture 2210 around the sample port 2204. The rinse fluid is then removed from the sample port 2204, the sample fluid line 2202, and the aperture 2210 through application of a vacuum to a fluid flush line 2300 in fluid communication with the aperture 2210.

Referring to FIG. 24A, the filter disengagement system 2200 is shown with the bottom port 816 of the filter 804 inserted within the sample port 2204 and with a disengagement structure 2400 to pull the sample port 2204 away from the filter 804 following filtrate transfer. The disengagement structure 2400 is shown defining an annular aperture 2410 formed around the sample port 2204. The filter disengagement system 2200 is also shown having a housing 2402 defining a collar 2404 configured to fit within the annular aperture 2410 around the sample port 2204 when the disengagement structure 2400 is in an engaged configuration. For instance, when the disengagement structure 2400 is in the engaged configuration, a bottom surface of the filter 804 can rest against a top surface 2412 of the housing 2402 while the bottom port 816 is positioned within the sample port 2204. In implementations, the sample port 2204 is substantially level with the top surface 2412 of the housing 2402 when the disengagement structure 2208 is in the engaged configuration.

Referring to FIG. 24B, the filter disengagement system 2200 is shown disengaging the filter 804 from the sample port 2204 by pulling the disengagement structure 2400 downwards away from the top surface 2412 of the housing 2402 within the collar 2404, which in turn maintains the the bottom surface of the filter 804 on the housing 2402 while the sample port 2204 is pulled away from the bottom port 806 of the filter 804. In implementations, the filter disengagement system 2200 includes a motor system 2414 coupled with the disengagement structure 2400 via a rod 2416 whereby retraction of the rod 2416 downwards causes a proportional movement downwards of the disengagement structure 2400 while the housing 2402 remains stationary. Referring to FIG. 24C, the filter disengagement system 2200 is shown with the filter 804 pulled away from the filter disengagement system 2200, such as through action by the autosampler arm 102 pulling the probe 700 away from the filter disengagement system 2200 while the disengagement structure 2400 is in a disengaged configuration. In implementations, the filter 804 can then be separated from the probe 700 via the filter retainer 120, such as in preparation to affix a new filter 804 onto the probe 700 for subsequent sample handling.

The filter disengagement system 2200 having the internal disengagement structure 2400 can also facilitate rinsing of the internal fluid passages, such as to rinse any residual fluids within or around the sample port 2204, the sample fluid line 2202, the collar 2404, or the like, prior to introduction of a filtrate from a subsequent sample. For example, FIG. 25A shows introduction of a rinse fluid into the sample outlet port 2206 for passage into the sample fluid line 2202 to backflush the rinse fluid into the aperture 2410 around the sample port 2204. The rinse fluid is then removed from the sample port 2204, the sample fluid line 2202, and the aperture 2410 through application of a vacuum to a fluid flush line 2500 (e.g., shown in FIG. 25B) in fluid communication with a rinse channel 2502 that fluidically couples with the aperture 2410 while the disengagement structure 2400 is in the disengaged configuration.

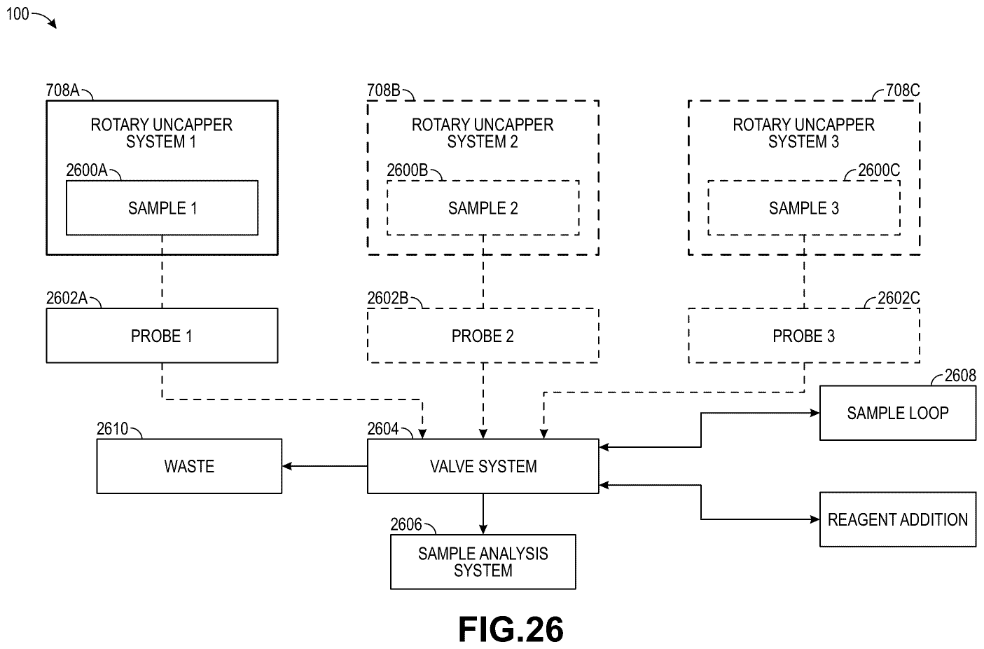

The system 100 can direct the filtrate to a sample analysis system for analytic determination of one or more components of the filtrate. For example, referring to FIG. 26, the system 100 is shown with a first rotary uncapper system 708A configured to handle a first sample 2600A for transfer by a first probe 2602A to a valve system 2604 in fluid communication with a sample analysis system 2606 (e.g., which can include the sample analysis system 704). The sample analysis system 2606 can include, but is not limited to, an inductively-coupled plasma (ICP) analytical instrument, such as an ICP mass spectrometer. In implementations, the valve system 2604 is in fluid communication with the filter disengagement system 2200 to receive the filtrate passed therethrough (e.g., via the sample outlet port 2206). The valve system 2604 can include one or more multiport valves configured to direct the filtrate to one or more additional locations, such as to a sample loop 2608 (e.g., to hold a desired amount of filtrate before transferring to the analysis system 2606), to a waste location 2610, or the like, or to introduce one or more fluids to the filtrate in an inline configuration of the valve system 2604 or another location, such as to introduce one or more reagents, internal standard solutions, diluents, or the like, or combinations thereof to provide a prepared filtrate sample. For example, the system 100 can introduce one or more reagents (e.g., acid(s)) to the filtrate prior to sending the sample to the analysis system 2606. Alternatively or additionally, the system 100 can introduce one or more reagents to a fluid sample without filtering through the filter 804, such as to measure an unfiltered acidified sample, which can be compared against analytic results of acidifying the filtrate from a fluid sample from the same fluid container 112.

In implementations, the valve system 2604 can receive filtrate from sample containers 112 originating from more than one rotary uncapper 708, such as where the analysis system 2606 can process a sample more rapidly than a sample can be handled by a given rotary uncapper 708 with subsequent filtration through the filter 804. For instance, when filtering samples having a high amount of particulates, the system 100 may transfer the sample through the filter 804 at a slower rate than for samples having less particulate loads to avoid clogging of system components or developing high internal pressures, where the slower flow rates produce a filtrate at a rate less than the rate of sample analysis by the analysis system 2606. For example, FIG. 26 shows the system 100 introducing filtrate from three separate probes (e.g., 2602A, 2602B, 2602C) that take sample from three separate samples (e.g., 2600A, 2600B, 2600C) handled by three separate rotary uncapper systems (e.g., 708A, 708B, 708C) to the valve system 2604 to maintain a high uptime for the analysis system 2606. While the system 100 is shown handling filtrate from three different sources, the system 100 is not limited to such configuration and can handle fluids from any number of sources, including less than three and more than three, without departing from the scope of the present disclosure.

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the autosampler arm 102, the rotary uncapper 708, the container placement system 706, the filter disengagement system 2200, the valve system 2604, alternative or additional fluid handling systems (e.g., valves, pumps, etc.), other components described herein, components directing control thereof, or combinations thereof. The program instructions, when executed by the processor or other controller, can cause the computing system to control the system 100 (e.g., control positioning of the uncapper head, the rotary stage, or the sample probe, control movement of fluids via the sample probe, etc.), control operation of the container scanner, or the like, according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### Conclusion

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An automated filtration system for sample preparation for chemical analyses comprising:
an autosampler arm configured to couple with a sample probe having a filter coupled to the sample probe, the autosampler arm configured to position the sample probe within a first sample container holding a fluid sample for filtering and subsequent analysis;
a pump/vacuum source configured to remove at least a portion of the fluid sample from the sample container and to transfer fluid sample through each of the filter and the sample probe to generate a filtrate; and
a control system communicatively coupled with each of the autosampler arm and the pump/vacuum source to cause the autosampler arm to position the autosampler arm adjacent at least one of a second sample container or a sample port in fluid communication with an analysis system and to cause the pump/vacuum source to dispense the filtrate into at least one of the second sample container or the sample port.

2. The automated filtration system of claim 1, wherein the sample probe is directly coupled with the autosampler arm, and wherein the sample probe includes a bottom end positioned distal from the autosampler arm, the bottom end configured to secure to a fluid port of the filter.

3. The automated filtration system of claim 2, wherein the bottom end includes a tapered outer surface that tapers inward towards an inner fluid channel through which the fluid sample is permitted to flow.

4. The automated filtration system of claim 3, wherein the tapered outer surface further defines a chamfer at a distal portion of the bottom end for insertion into the fluid port of the filter.

5. The automated filtration system of claim 2, wherein the filter includes a second port downstream from the first port relative to the sample probe, wherein the control system is configured to cause the autosampler arm to position the sample probe adjacent the sample port in fluid communication with the analysis system and to fluidically couple the second port with the sample port to dispense the filtrate from the second port into the sample port for analysis by the analysis system.

6. The automated filtration system of claim 5, wherein the sample port is coupled with a filter disengagement system defining a housing configured to separate a bottom surface of the filter from the sample port while permitting coupling between the second port of the filter and the sample port.

7. The automated filtration system of claim 6, wherein the filter disengagement system includes a disengagement structure coupled with the housing, the disengagement structure configured to extend away from the sample port to push the bottom surface of the filter from the sample port to permit decoupling of the second port of the filter and the sample port.

8. The automated filtration system of claim 6, wherein the filter disengagement system includes a disengagement structure coupled with the sample port, the disengagement structure configured to retract away from the housing to pull the sample port from the second port of the filter while retaining the bottom surface of the filter on the housing to permit decoupling of the second port of the filter and the sample port.

9. The automated filtration system of claim 1, wherein the sample probe is integrated with a bottom port of the filter, and wherein the filter includes a top port configured to detachably engage with an end of the autosampler arm.

10. The automated filtration system of claim 9, wherein the pump/vacuum source is configured to draw the fluid sample through the sample probe and into the filter and to direct the filtrate into a fluid line fluidically coupled with the filter and the sample probe.

11. The automated filtration system of claim 10, further comprising a filter retainer configured to remove the filter and integrated sample probe from the autosampler arm, the filter retainer defining a front aperture into which the filter and integrated sample probe is permitted to pass and defining a top aperture into which the end of the autosampler arm is permitted to pass, wherein upon lifting of the autosampler arm, the filter is held against an inner surface of the filter retainer and removed from the end of the autosampler arm.

12. The automated filtration system of claim 10, wherein the control system is configured to cause the autosampler arm to position the end of the autosampler arm adjacent the second sample container subsequent to filter removal.

13. An automated filtration system for sample preparation for chemical analyses comprising:
an autosampler arm configured to couple with a sample probe having a filter coupled to the sample probe, the autosampler arm configured to position the sample probe within a first sample container holding a fluid sample for filtering and subsequent analysis;
a rotary uncapper including a stage configured to support the first sample container and an uncapper head configured to remove a cap from the first sample container prior to introduction of the sample probe to the first sample container;
a pump/vacuum source configured to remove at least a portion of the fluid sample from the sample container and to transfer fluid sample through each of the filter and the sample probe to generate a filtrate; and
a control system communicatively coupled with each of the autosampler arm and the pump/vacuum source to cause the autosampler arm to position the autosampler arm adjacent at least one of a second sample container or a sample port in fluid communication with an analysis system and to cause the pump/vacuum source to dispense the filtrate into at least one of the second sample container or the sample port.

14. The automated filtration system of claim 13, wherein the sample probe is directly coupled with the autosampler arm, and wherein the sample probe includes a bottom end positioned distal from the autosampler arm, the bottom end configured to secure to a fluid port of the filter.

15. The automated filtration system of claim 14, wherein the bottom end includes a tapered outer surface that tapers inward towards an inner fluid channel through which the fluid sample is permitted to flow.

16. The automated filtration system of claim 15, wherein the tapered outer surface further defines a chamfer at a distal portion of the bottom end for insertion into the fluid port of the filter.

17. The automated filtration system of claim 14, wherein the filter includes a second port downstream from the first port relative to the sample probe, wherein the control system is configured to cause the autosampler arm to position the sample probe adjacent the sample port in fluid communication with the analysis system and to fluidically couple the second port with the sample port to dispense the filtrate from the second port into the sample port for analysis by the analysis system.

18. The automated filtration system of claim 17, wherein the sample port is coupled with a filter disengagement system defining a housing configured to separate a bottom surface of the filter from the sample port while permitting coupling between the second port of the filter and the sample port.

19. The automated filtration system of claim 13, wherein the sample probe is integrated with a bottom port of the filter, and wherein the filter includes a top port configured to detachably engage with an end of the autosampler arm.

20. The automated filtration system of claim 19, wherein the pump/vacuum source is configured to draw the fluid sample through the sample probe and into the filter and to direct the filtrate into a fluid line fluidically coupled with the filter and the sample probe.
